(19) United States
(12) Patent Application Publication
(10) Pub. No.: US 2011/0191734 A1
(43) Pub. Date: Aug. 4, 2011

(54) DESIGNING APPARATUS, DESIGNING METHOD, AND COMPUTER READABLE MEDIUM

(75) Inventors: Jiro HAYAKAWA, Tokyo (JP); Naoyuki KAWABE, Yokosuka-shi (JP); Hiroshige ORITA, Kawasaki-shi (JP); Takashi BAN, Yokohama-shi (JP)

(73) Assignee: KABUSHIKI KAISHA TOSHIBA, Tokyo (JP)

(21) Appl. No.: 12/887,044

(22) Filed: Sep. 21, 2010

(30) Foreign Application Priority Data
Feb. 4, 2010 (JP) 2010-23249

(51) Int. Cl. G06F 17/50

(52) U.S. Cl. 716/108

(57) ABSTRACT

In general, according to one embodiment, a designing apparatus includes a clock tree generator, a logic modifier, a layout modifier, and an outputting module. The clock tree generator is configured to generate a clock tree. The logic modifier is configured to logically insert a delay element in such a manner that a hold violation is modified without considering a setup timing with respect to circuit data corresponding to the clock tree generated by the clock tree generator. The layout modifier is configured to modify a layout of a semiconductor integrated circuit based on a processing result of the logic modifier. The outputting module is configured to output the layout of the semiconductor integrated circuit. The layout is modified by the layout modifier.

### CROSS REFERENCE TO RELATED APPLICATIONS

This application is based upon and claims the benefit of priority from the prior Japanese Patent Application No. 2010-23249, filed on Feb. 4, 2010, the entire contents of which are incorporated herein by reference.

### FIELD

The present invention relates to a designing apparatus, a designing method, and a computer readable medium.

### BACKGROUND

Ordinarily, in designing a semiconductor integrated circuit, a clock tree is generated by CTS (Clock Tree Synthesis), a timing violation is modified in the clock tree, and then a layout of the semiconductor integrated circuit is modified such that the timing violation is modified in the modified layout. The timing violation includes a setup violation and a hold violation.

Conventionally, in designing the semiconductor integrated circuit (for example, see JP-A No. 2009-37635 (Kokai)), the hold violation is modified such that the setup violation does not occur when the timing violation is modified. In other words, in designing the semiconductor integrated circuit, the hold violation is modified in consideration of the setup timing.

However, it is a problem that the number of inserted delay elements is increased because a position at which the delay element is inserted to modify the hold violation is restricted in consideration of the setup timing. For example, when the delay element is inserted in a common pass of the plural hold violations, the plural hold violations are modified by one delay element, while the setup violation is easy to occur. Accordingly, it is necessary to insert the delay element in a non-common pass in order that the hold violation is modified while the setup violation does not occur. As a result, the number of inserted delay elements increases.

Further, in consideration of the setup timing, it is a problem that the number of delay elements necessary for modifying the hold violation cannot be inserted. As a result, the hold violation which is not modified remains.

On the other hand, conventionally, in designing the semiconductor integrated circuit, a distance between the position at which the delay element is inserted to modify the hold violation and an input pin of a logic cell tends to be increased in the modification of the layout of the semiconductor integrated circuit.

However, when the distance between the position at which the delay element is inserted and the input pin of the logic cell is increased, it is a problem that a length of an interconnection between the input pin of the logic cell and the delay element is lengthened.

As described above, conventionally, in designing the semiconductor integrated circuit, there are various problems in the modification of the timing violation because the hold violation is modified in consideration of the setup timing. The problems cause a lengthened design time and an expanded scale of the semiconductor integrated circuit.

### BRIEF DESCRIPTION OF THE DRAWINGS

FIG. 1 is a block diagram illustrating a configuration of a designing apparatus 10 of the embodiment.

FIG. 2 is a schematic diagram illustrating a function of causing a computer to perform a designing method of the embodiment.

FIG. 3 is a flowchart illustrating a design procedure of the semiconductor integrated circuit of the embodiment.

FIG. 4 is a flowchart illustrating a procedure in clock tree generation (S301) of FIG. 3.

FIG. 5 is a schematic diagram of a clock tree generated in generating clock tree (S401) of FIG. 4.

FIG. 6 is a flowchart illustrating a procedure in calculating setup margin (S403) of FIG. 4.

FIG. 7 is a schematic diagram of a clock tree modified in modifying clock (S405) of FIG. 4.

FIG. 8 is a table illustrating setup margin in each pass, which is modified in modifying clock (S405) of FIG. 4.

FIG. 9 is a flowchart of a procedure of the first example in logic modification (S302) of FIG. 3.

FIG. 10 is a flowchart illustrating a procedure of the second example of logic modification (S302) of FIG. 3.

FIG. 11 is a flowchart illustrating a procedure of layout modification (S303) of FIG. 3.

FIG. 12 is a schematic diagram illustrating a layout of the semiconductor integrated circuit.

FIG. 13 is a schematic diagram illustrating the layout of the semiconductor integrated circuit corresponding to the result of adding delay element (S1106) of FIG. 11.

### DETAILED DESCRIPTION

Embodiments will now be explained with reference to the accompanying drawings.

In general, according to one embodiment, a designing apparatus comprises a clock tree generator, a logic modifier, a layout modifier, and an outputting module. The clock tree generator is configured to generate a clock tree. The logic modifier is configured to logically insert a delay element in such a manner that a hold violation is modified without considering a setup timing with respect to circuit data corresponding to the clock tree generated by the clock tree generator. The layout modifier is configured to modify a layout of a semiconductor integrated circuit based on a processing result of the logic modifier. The outputting module is configured to output the layout of the semiconductor integrated circuit. The layout is modified by the layout modifier.

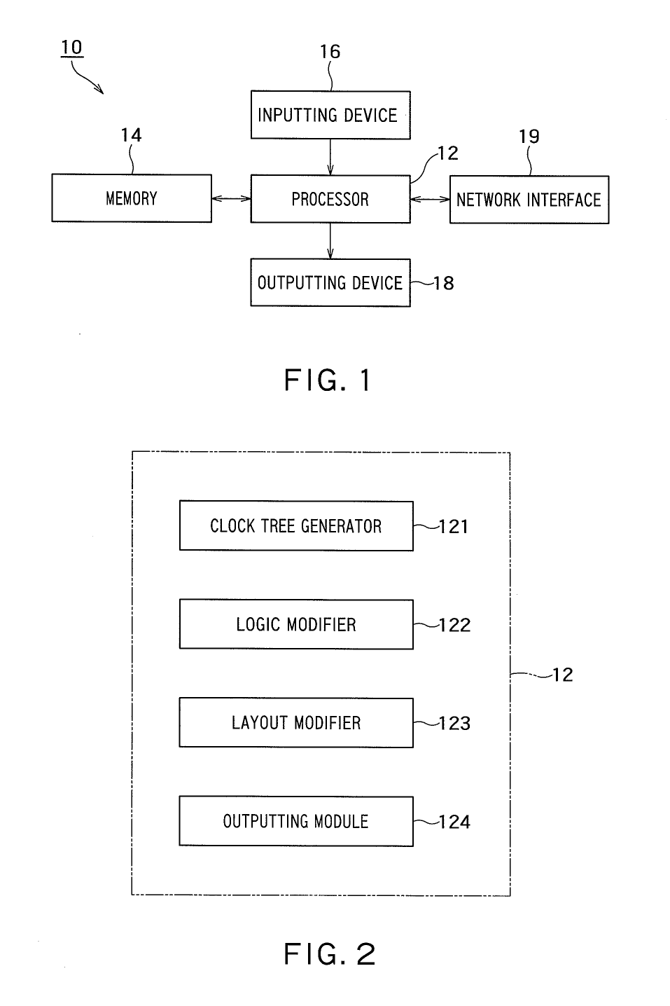

A configuration of a designing apparatus according to an embodiment will be explained below. FIG. 1 is a block diagram illustrating a configuration of a designing apparatus 10 of the embodiment. FIG. 2 is a schematic diagram illustrating a function of causing a computer to perform a designing method of the embodiment.

Referring to FIG. 1, the designing apparatus 10 includes a processor 12, a memory 14, an inputting device 16, an outputting device 18, and a network interface 19. The memory 14, the inputting device 16, the outputting device 18, and the network interface 19 are connected to the processor 12. A designing program that causes the computer to perform the designing method of the embodiment is stored in the memory 14. The memory 14 is a computer-readable storage medium such as a nonvolatile semiconductor storage device. A network terminal (not illustrated) such as a server is connected to the network interface 19. For example, the inputting device 16 is a keyboard and the outputting device 18 is a liquid crystal display.

The processor 12 of FIG. 1 starts the designing program stored in the memory 14, thereby realizing the function of causing the computer to perform the designing method of the embodiment. Specifically, a clock tree generator 121, a logic modifier 122, a layout modifier 123, and an outputting module 124 are realized as illustrated in FIG. 2.

The clock tree generator 121 of FIG. 2 is configured to generate a clock tree by the CTS.

The logic modifier 122 of FIG. 2 is configured to logically insert a delay element such that the hold violation is modified without considering the setup timing with respect to circuit data corresponding to the clock tree generated by the clock tree generator 121.

The layout modifier 123 of FIG. 2 is configured to modify a layout of the semiconductor integrated circuit based on the processing result of the logic modifier 122. Specifically, the layout modifier 123 modifies the disposition of the logic cell and the interconnection between the logic cells according to the delay element which is logically inserted.

The outputting module 124 of FIG. 2 is configured to output the layout of the semiconductor integrated circuit, which is modified by the layout modifier 123.

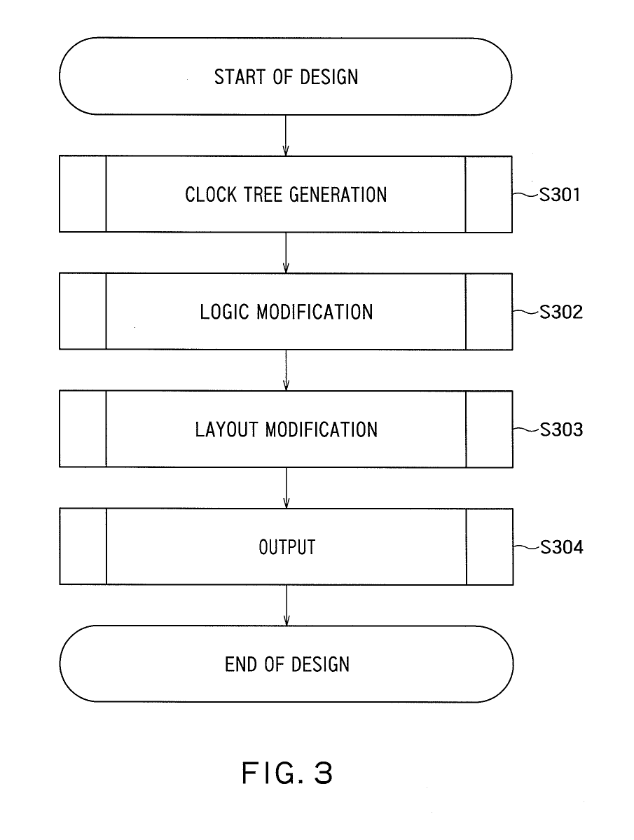

A designing method of the embodiment will be explained. FIG. 3 is a flowchart illustrating a design procedure of the semiconductor integrated circuit of the embodiment.

The design of FIG. 3 is performed in order to modify the timing violation of the semiconductor integrated circuit.

<FIG. 3: Clock Tree Generation (S301)>

The clock tree generator 121 generates the clock tree by the CTS. Clock tree generation (S301) is explained in detail below.

<FIG. 3: Logic Modification (S302)>

The logic modifier 122 logically inserts the delay element in the circuit data corresponding to the clock tree generated in clock tree generation (S301) such that the hold violation is modified without considering the setup timing. Logic modification (S302) is explained in detail below.

<FIG. 3: Layout Modification (S303)>

The layout modifier 123 modifies the layout of the semiconductor integrated circuit based on the processing result in logic modification (S302). Layout modification (S303) is explained in detail below.

<FIG. 3: Output (S304)>

The outputting module 124 outputs the layout of the semiconductor integrated circuit, which is modified in layout modification (S303). The design of the embodiment is ended after output (S304).

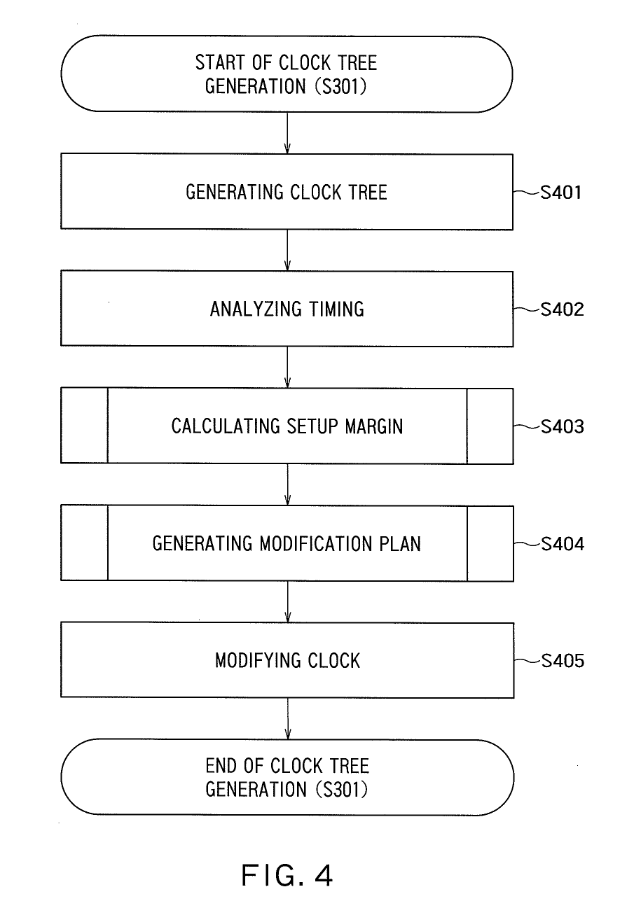

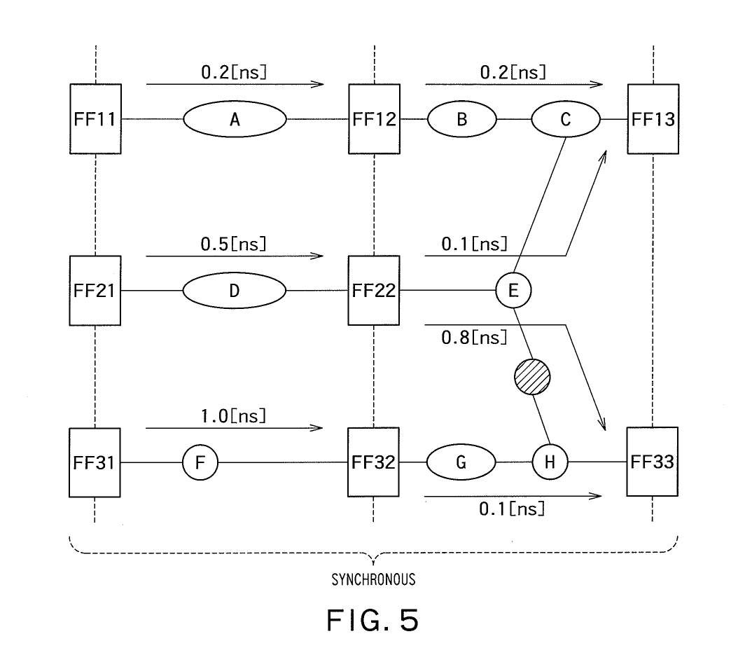

An example of clock tree generation (S301) will be explained in detail. FIG. 4 is a flowchart illustrating a procedure in clock tree generation (S301) of FIG. 3. FIG. 5 is a schematic diagram of a clock tree generated in generating clock tree (S401) of FIG. 4.

<FIG. 4: Generating Clock Tree (S401)>

The clock tree generator 121 generates the clock tree by the CTS and optimizes the clock using a zero-skew method or a useful-skew method. Therefore, the clock tree of FIG. 5 is generated. The clock tree includes a logic cell such as a flipflop and a buffer, a node between the logic cells, and a pass that connects the logic cells through the node. Flipflops FF11 to FF13, FF21, FF22, and FF31 to FF33, nodes A to H, and passes PA, PBC, PD, PEC, PEH, PF, and PGH are illustrated in FIG. 5.

<FIG. 4: Analyzing Timing (S402)>

The clock tree generator 121 analyzes the setup timing, an amount of the setup violation, and a clock delay between the flipflops in all the flipflops with respect to the circuit data corresponding to the clock tree generated in generating clock tree (S401).

<FIG. 4: Calculating Setup Margin (S403)>

The clock tree generator 121 calculates a margin (hereinafter referred to as “setup margin”) of the setup timing to the setup violation based on the result in analyzing timing (S402).

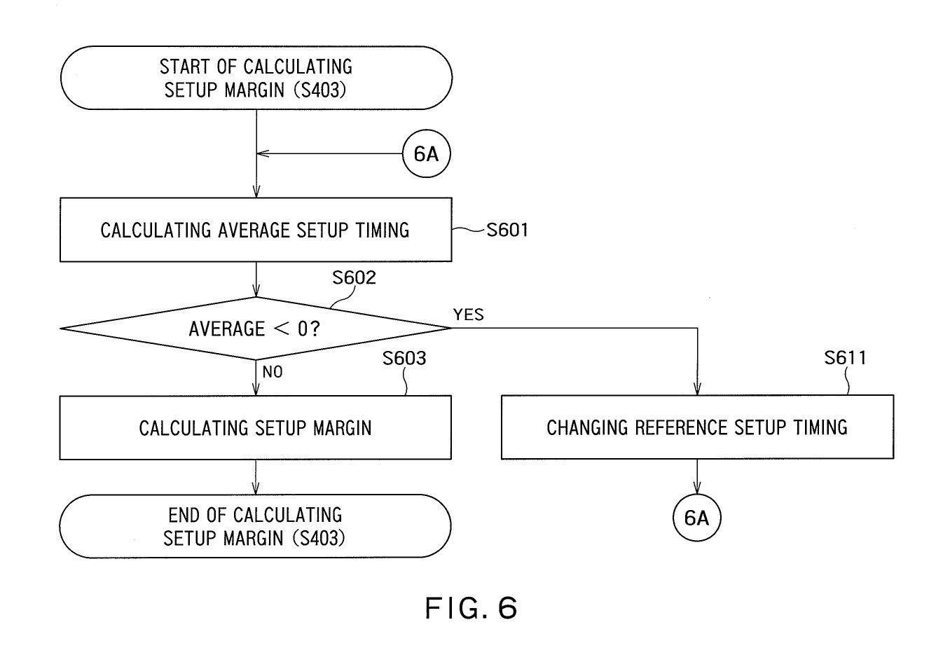

Calculating setup margin (S403) will be explained in detail. FIG. 6 is a flowchart illustrating a procedure in calculating setup margin (S403) of FIG. 4.

<FIG. 6: Calculating Average Setup Timing (S601)>

The clock tree generator 121 calculates an average value of reference setup timing (for example, setup timing between the flip-flop FF11 and flipflop FF12 of FIG. 5) and setup timing (for example, the flipflop FF12 and flipflop FF13 of FIG. 5) subsequent to the reference setup timing with respect to the circuit data corresponding to the clock tree generated in generating clock tree (S401) of FIG. 4. The initial reference setup timing is setup timing between the flipflops including the leading flipflop (for example, the flipflops FF11, FF21, and FF31 of FIG. 5).

<FIG. 6: S602>

The clock tree generator 121 makes a determination of magnitude of the average value calculated in calculating average setup timing (S601) (S602). When the average value is not lower than zero (that is, in the case that the setup timing has a margin) (NO in S602), the flow goes to calculating setup margin (S603). When the average value is negative (that is, the case that the setup timing has no margin) (YES in S602), the flow goes to changing reference setup timing (S611).

<FIG. 6: Calculating Setup Margin (S603)>

The clock tree generator 121 calculates a difference between the setup timing analyzed in analyzing timing (S402) of FIG. 4 and the average value calculated in calculating average setup timing (S601). The difference is the setup margin. That is, the setup margin indicates a degree in which the setup timing can be delayed. In other words, when the setup timing is delayed by the setup margin, what the hold violation to be modified is permitted. Calculating setup margin (S403) of FIG. 4 is ended after calculating setup margin (S603).

<FIG. 6: Changing Reference Setup Timing (S611)>

The clock tree generator 121 changes the reference setup timing. Therefore, the setup timing subsequent to the reference setup timing in calculating average setup margin (S601) becomes new reference setup timing. The flow returns to calculating average setup timing (S601) after changing reference setup timing (S611).

FIG. 5 illustrates the case, where the pass PA has the setup margin of 0.2 [ns], the pass PBC has the setup margin of 0.2 [ns], the pass PD has the setup margin of 0.5 [ns], the pass PEC has the setup margin of 0.1 [ns], the pass PEH has the setup margin of 0.8 [ns], the pass PF has the setup margin of 1.0 [ns], the pass PGH has the setup margin of 0.1 [ns], and the hold violation of 0.5 [ns] is generated in the pass PEH.

<FIG. 4: Generating Modification Plan (S404)>

The clock tree generator 121 generates a modification plan to modify the clock. Specifically, the clock tree generator 121 adds the setup margin, calculated in calculating setup margin (S603) of FIG. 6, to the clock delay analyzed in analyzing timing (S402). Then, the clock tree generator 121 generates the modification plan to modify the clock based on the sum of the clock delay and the setup margin. Specifically, the clock tree generator 121 sets the sum of the clock delay and the setup margin to a target value in order to put the clock forward in the portion in which the setup margin is negative. Then, the clock tree generator 121 re-generates the clock tree such that the target value is satisfied. On the other hand, the clock tree generator 121 logically inserts the delay element corresponding to the setup margin in the portion in which the setup margin is zero or more. Therefore, as illustrated in FIG. 5, the modification plan is generated in which the setup timing of the flipflop FF22 is put back 0.3 [ns] while the setup timing of the flipflop FF32 is put forward 0.5 [ns].

<FIG. 4: Modifying Clock (S405)>

The clock tree generator 121 modifies the clock of the logic cell based on the modification plan generated in generating modification plan (S404). Clock tree generation (S301) of FIG. 3 is ended after modifying clock (S405).

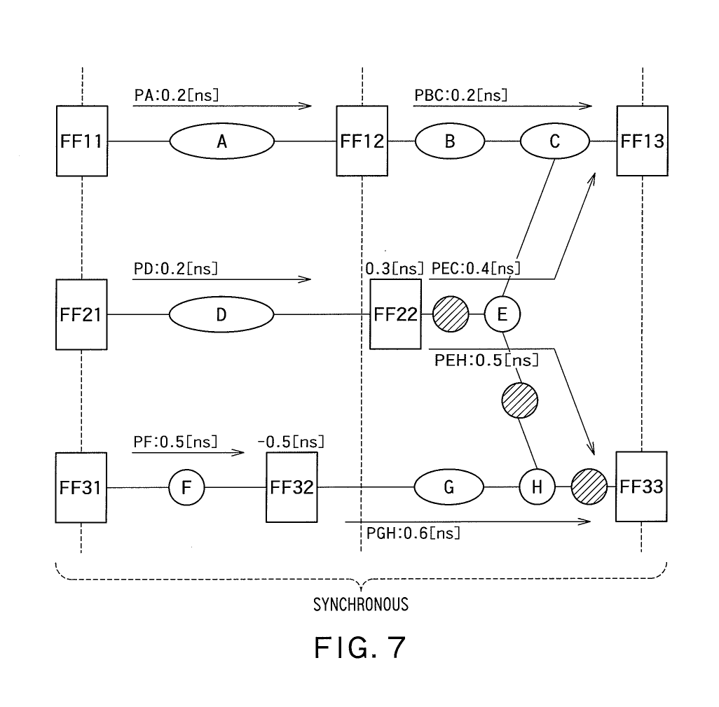

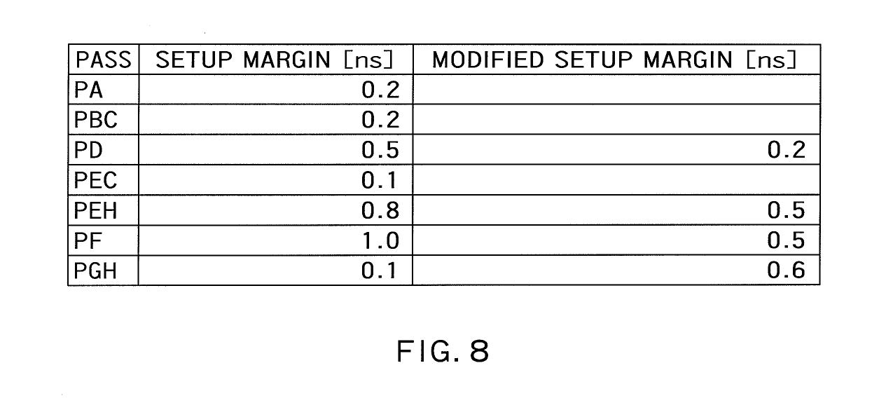

Modifying clock (S405) will be explained in detail. FIG. 7 is a schematic diagram of a clock tree modified in modifying clock (S405) of FIG. 4. FIG. 8 is a table illustrating setup margin in each pass, which is modified in modifying clock (S405) of FIG. 4.

As illustrated in FIG. 7, in modifying clock (S405), the positions of the flipflop FF22 and flipflop FF32 are changed in the clock tree. As a result, as illustrated in FIGS. 7 and 8, the setup margin of the pass PD changes from 0.5 [ns] to 0.2 [ns], the setup margin of the pass PEH changes from 0.8 [ns] to 0.5 [ns], the setup margin of the pass PF changes from 1 [ns] to 0.5 [ns], and the setup margin of the pass PGH changes from 0.1 [ns] to 0.6 [ns]. As illustrated in FIG. 7, the hold violation of 0.2 [ns] occurs in the pass PEH.

As described above, in clock tree generation (S301) of FIG. 3, the clock tree generator 121 changes the setup margin of the clock tree. In other words, the clock tree generator 121 changes the position of the logic cell on the clock tree in the modification plan, thereby reducing the difference between the maximum value and the minimum value of the setup margin. That is, the clock tree generator 121 equalizes the setup margins of all the passes in the clock tree. As a result, the setup margins of the passes PD, PEH, and PF having the relatively large degree are decreased, and the setup margin of the pass PGH having the relatively small degree is increased. Therefore, it becomes easier to modify the hold violation.

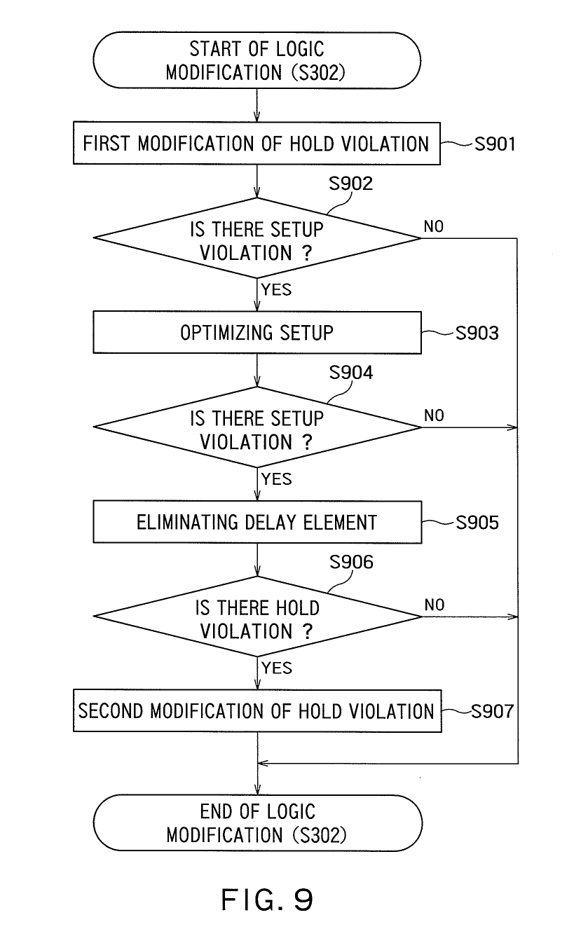

A first example of logic modification (S302) will be explained. FIG. 9 is a flowchart of a procedure of the first example in logic modification (S302) of FIG. 3.

<FIG. 9: First Modification of Hold Violation (S901)>

The logic modifier 122 modifies the hold violation with respect to the circuit data corresponding to the clock tree generated in generating clock tree (S302) of FIG. 3. Specifically, the logic modifier 122 extracts the violation pass including the hold violation, specifies the common node common to the plural violation passes, and inserts the delay element corresponding to an amount of the hold violation in the common node. Therefore, the hold violation is resolved. At this point, although there is a possibility that the setup violation occurs due to the inserted delay element, the logic modifier 122 inserts the delay element in order to resolve the hold violation even if the setup violation occurs. That is, in first modification of hold violation (S901), the hold violation is modified without considering the setup violation.

<FIG. 9: S902>

Based on the result of first modification of hold violation (S901), the logic modifier 122 determines whether there is the setup violation or not by comparing the setup timing and a predetermined setup restriction (S902). When there is the setup violation (YES in 902), the flow goes to optimizing setup (S903). When there is not the setup violation (NO in S902), logic modification (S302) of FIG. 3 is ended.

<FIG. 9: Optimizing Setup (S903)>

The logic modifier 122 specifies the violation pass whose the amount of the setup violation is the maximum, and optimizes the setup violation of the violation pass until the setup violation is resolved. Specifically, the logic modifier 122 optimizes the setup violation by enlarging the size of the logic cell, inserting or eliminating the logic cell, and changing the disposition of the logic cell.

<FIG. 9: S904>

Based on the result of optimizing setup (S903), the logic modifier 122 determines whether there is the setup violation or not by comparing the setup timing and a predetermined setup restriction (S904). When there is the setup violation (YES in S904), the flow goes to eliminating delay element (S905). When there is not the setup violation (NO in S904), logic modification (S302) of FIG. 3 is ended.

<FIG. 9: Eliminating Delay Element (S905)>

The logic modifier 122 eliminates the delay element remaining on the violation pass of the delay elements inserted in first modification of hold violation (S901) until the setup violation is resolved. That is, after eliminating delay element (S905), the circuit data corresponds to the clock tree generated in clock tree generation (S301) of FIG. 3.

<FIG. 9: S906>

Based on the result of eliminating delay element (S905), the logic modifier 122 determines whether there is the hold violation or not by comparing the hold timing and a predetermined hold restriction (S906). When there is the hold violation (YES in S906), the flow goes to second modification of hold violation (S907). When there is not the hold violation does not (NO in S906), logic modification (S302) of FIG. 3 is ended.

<FIG. 9: Second Modification of Hold Violation (S907)>

The logic modifier 122 modifies the hold violation of the circuit data corresponding to the clock tree generated in clock tree generation (S301) of FIG. 3. Specifically, the logic modifier 122 extracts the violation pass including the hold violation, specifies the common node common to the plural violation passes, calculates the setup margin of the common node similarly to calculating setup margin (S403) of FIG. 4, and inserts the delay element corresponding to a smaller value of the amount of the hold violation and the setup margin in the common node. Second modification of hold violation (S907) is applied to all the common nodes. Therefore, the hold violation is modified in consideration of the setup violation.

After second modification of hold violation (S907), logic modification (S302) of FIG. 3 is ended.

As described above, in the first example of logic modification (S302) of FIG. 3, the logic modifier 122 modifies the setup violation after the delay element is logically inserted. When the setup violation cannot be modified, the logic modifier 122 eliminates the logically inserted delay element. In other words, the logic modifier 122 modifies the hold violation without considering the setup violation, and logic modification (S302) is ended when the setup violation does not remain. Therefore, the time necessary to modify the hold violation can be shortened.

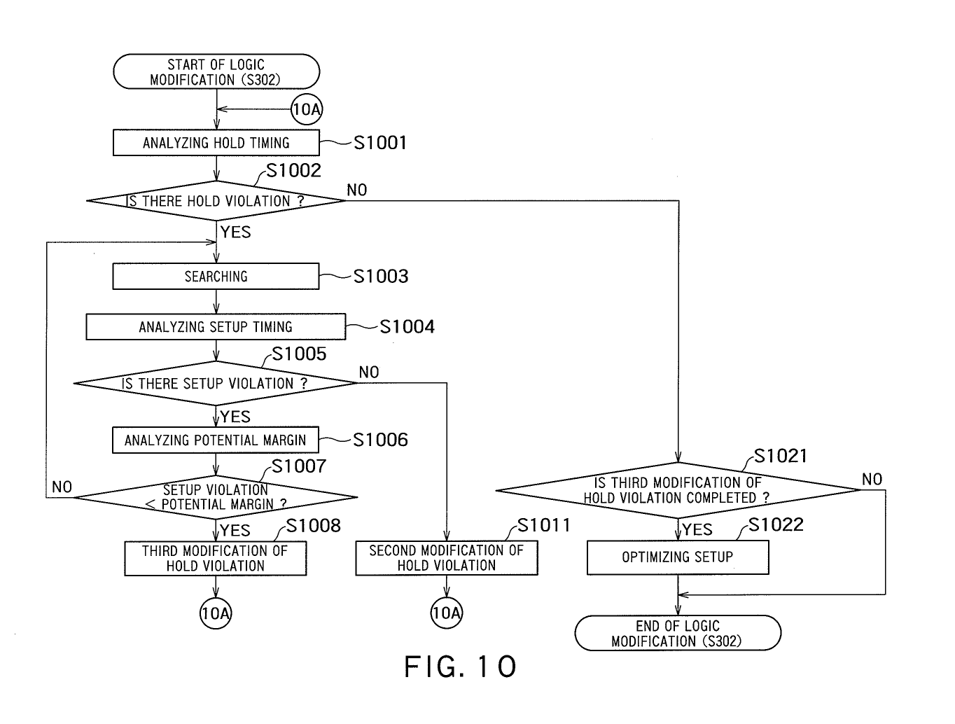

A second example of logic modification (S302) will be explained. FIG. 10 is a flowchart illustrating a procedure of the second example of logic modification (S302) of FIG. 3.

<FIG. 10: Analyzing Hold Timing (S1001)>

The logic modifier 122 analyzes the hold timing between the flipflops in all the flipflops with respect to the circuit data corresponding to the clock tree generated in generating clock tree (S401) of FIG. 4.

<FIG. 10: S1002>

The logic modifier 122 determines whether there is the hold violation or not by comparing the hold timing analyzed in analyzing hold timing (S1001) and a predetermined hold restriction (S1002). When there is the hold violation (YES in S1002), the flow goes to searching (S1003). When there is not the hold violation (NO in S1002) the flow goes to S1021.

<FIG. 10: Searching (S1003)>

The logic modifier 122 searches a position at which the delay element can be inserted with respect to the violation pass including the hold violation.

<FIG. 10: Analyzing Setup Timing Analyzing (S1004)>

Based on the result of searching (S1003), the logic modifier 122 analyzes the setup timing in the case that the delay element is inserted.

<FIG. 10: S1005>

The logic modifier 122 determines whether there is the setup violation or not in the case that the delay element is inserted based on the result of searching (S1003) by comparing the setup timing analyzed in analyzing setup timing (S1004) and a predetermined setup restriction (S1005). When there is the setup violation (YES in S1005), the flow goes to analyzing potential margin (S1006). When there is not the setup violation (NO in S1005), the flow goes to second modification of hold violation (S1011).

<FIG. 10: Analyzing Potential Margin (S1006)>

The logic modifier 122 analyzes a potential margin of the setup timing to the setup violation. The potential margin indicates a permissible range of the amount of the setup violation caused by the inserted delay element.

A first example of analyzing potential margin (S1006) will be explained. In the first example of analyzing potential margin (S1006), the logic modifier 122 inserts a temporary delay element in the violation pass and performs processing similar to that in optimizing setup (S903) of FIG. 9 to try whether the hold violation can be improved. In the first example of analyzing potential margin (S1006), accuracy of the modification of the hold violation can be improved.

A second example of analyzing potential margin (S1006) will be described. In the second example of analyzing potential margin (S1006), the logic modifier 122 assumed that X is a delay value per logic cell from the data in the past design, multiplies the delay value X and the number of logic cells on the violation pass (hereinafter referred to as “object setup pass”) in which the temporary delay element is inserted, and calculates a difference between a delay value X₀ of the violation pass before the temporary delay element is inserted and the multiplication. The calculated difference is the potential margin. In the second example of analyzing potential margin (S1006), the necessary time for logic modification (S302) can be shortened.

A third example of analyzing potential margin (S1006) will be explained. In the third example of analyzing potential margin (S1006), the logic modifier 122 calculates an average value X_{AVE} of the delay values of macro cells from the semiconductor integrated circuit before the temporary delay element is inserted, adds the average value X_{AVE} and a target value (predetermined value) X_{T} of the delay value of each logic cell on the object setup pass, and calculates a difference between the delay value X₀ of the violation pass before the temporary delay element is inserted and the addition result. The calculated difference is the potential margin. Therefore, both the accuracy of the modification of the hold violation and the necessary time for logic modification (S302) can be improved.

<FIG. 10: S1007>

The logic modifier 122 makes a determination of a magnitude relation between the potential margin analyzed in analyzing potential margin (S1006) and the setup violation (S1007). When the potential margin is larger than the setup violation (YES in S1007), the flow goes to third modification of hold violation (S1008). When the potential margin is equal to or smaller than the setup violation (NO in S1007), the flow returns to searching (S1003).

<FIG. 10: Third Modification of Hold Violation (S1008)>

The logic modifier 122 inserts the delay element in the position searched in searching (S1003). That is, the delay element is inserted in consideration of the potential margin. Therefore, the hold violation is resolved while the setup violation does not occur. After third modification of hold violation (S1008), the flow returns to analyzing hold timing (S1001).

<FIG. 10: Second Modification of Hold Violation (S1011)>

The logic modifier 122 performs processing similar to that in second modification of hold violation (S907) of FIG. 9. That is, the hold violation is modified in consideration of the setup violation. After second modification of hold violation (S1011), the flow returns to analyzing hold timing (S1001).

<FIG. 10: S1021>

The logic modifier 122 determines whether third modification of hold violation (S1008) is completed (S1021). When the third modification of hold violation (S1008) is completed (YES in S1021), the flow goes to optimizing setup (S1022). When third modification of hold violation (S1008) is not completed (NO in S1021), logic modification (S302) of FIG. 3 is ended. That is, optimizing setup (S1022) is performed when the delay element is inserted in consideration of the potential margin.

<FIG. 10: Optimizing Setup (S1022)>

The logic modifier 122 performs processing similar to that in optimizing setup (S903) of FIG. 9. After optimizing setup (S1022), logic modification (S302) of FIG. 3 is ended.

As described above, in the second example of logic modification (S302) of FIG. 3, the logic modifier 122 analyzes the potential margin of the setup timing to the setup violation and logically inserts the delay element based on the analytical result. Further, the logic modifier 122 logically inserts the delay element when the potential margin is included in a predetermined permissible range. In other words, when there is the potential margin of the setup timing, the logic modifier 122 modifies the hold violation in consideration of the potential margin even if the setup violation occurs. Therefore, both the accuracy of the modification of the hold violation and the time necessary for logic modification (S302) can be improved.

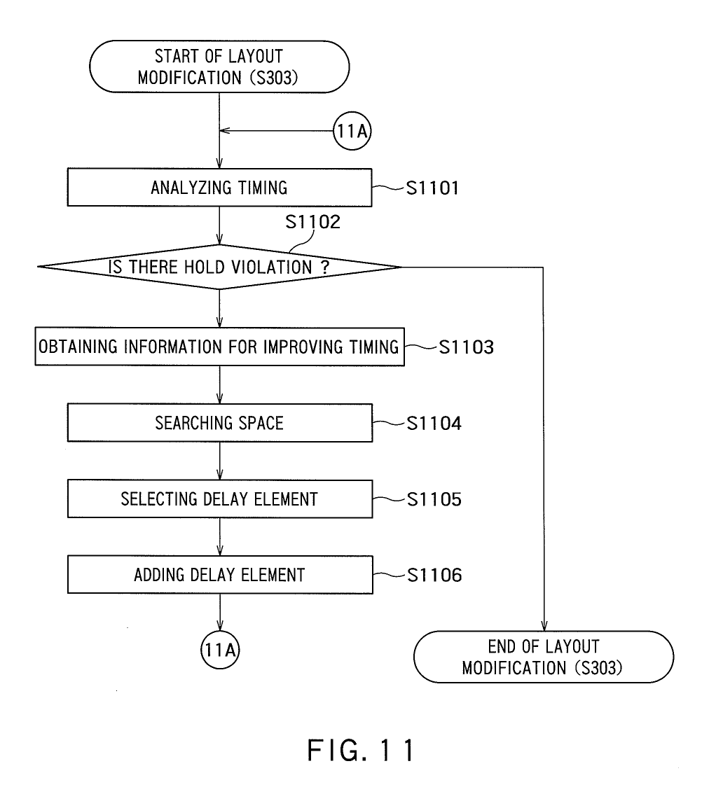

An example of layout modification (S303) will be explained. FIG. 11 is a flowchart illustrating a procedure of layout modification (S303) of FIG. 3.

<FIG. 11: Analyzing Timing (S1101)>

The layout modifier 123 analyzes the setup timing, hold timing, amount of the hold violation, and clock delay between the flipflops in all the flipflops with respect to the circuit data after logic modification (S302) of FIG. 3.

<FIG. 11: S1102)>

The layout modifier 123 determines whether there is the hold violation or not by comparing the hold timing analyzed in analyzing timing (S1101) a predetermined hold restriction (S1102). When there is the hold violation (YES in S1102), the flow goes to obtaining information for improving timing (S1103). When there is not the hold violation (NO in S1102), layout modification (S303) of FIG. 3 is ended.

<FIG. 11: Obtaining Information for Improving Timing (S1103)>

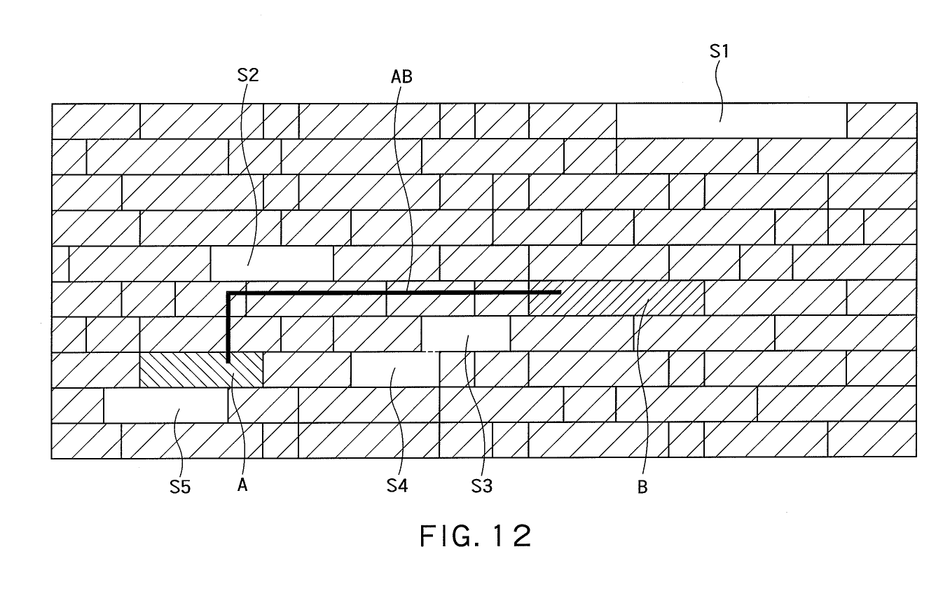

The layout modifier 123 obtains information for improving timing. The information for improving timing includes positional information (coordinate) of a net having the hold violation and positional information (coordinate) of the logic cell connected to the net having the hold violation. Therefore, information necessary to resolve the hold violation in consideration of the setup violation is obtained. FIG. 12 is a schematic diagram illustrating a layout of the semiconductor integrated circuit. For example, in FIG. 12, assuming that a net AB connecting a logic cell A and a logic cell B has the hold violation, positional information of the net AB, the logic cell A, and the logic cell B is obtained in obtaining information for improving timing (S1103).

<FIG. 11: Searching Space (S1104)>

The layout modifier 123 searches a space near the logic cell based on the positional information on the logic cell, which is obtained in obtaining information for improving timing (S1103). The layout modifier 123 obtains a coordinate and a width of the searched space. Therefore, the space in which the delay element can be inserted and the space information are searched. For example, in FIG. 12, the coordinates and the widths of spaces 51 to S5 are obtained. For example, the space 51 has the width of 10 [μm], the space S2 has the width of 5 [μm], the space S3 has the width of 3 [μm], the space S4 has the width of 3 [μm], and the space S5 has the width of 5 [μm]. The spaces S2 to S5 are located near the logic cell B, and the space 51 is located away from the logic cell B.

<FIG. 11: Selecting Delay Element (S1105)>

The layout modifier 123 specifies plural delay elements that can be disposed in the spaces searched in searching space (S1104), and selects a combination of delay elements having a necessary amount of delay from the specified plural delay elements. Specifically, properties (the width of the delay element and the timing value to be improved) of the delay elements are stored in the memory 14. Based on the properties of the delay element, the size of the space, and the amount of the hold violation, the layout modifier 123 selects the type and the size of the delay element that can be inserted to resolve the hold violation in consideration of the setup violation. When the plural delay elements that can be inserted to resolve the hold violation exist, the delay element is selected based on a predetermined priority (for example, the delay element which is most effective to modify the timing violation is selected).

<FIG. 11: Adding Delay Element (S1106)>

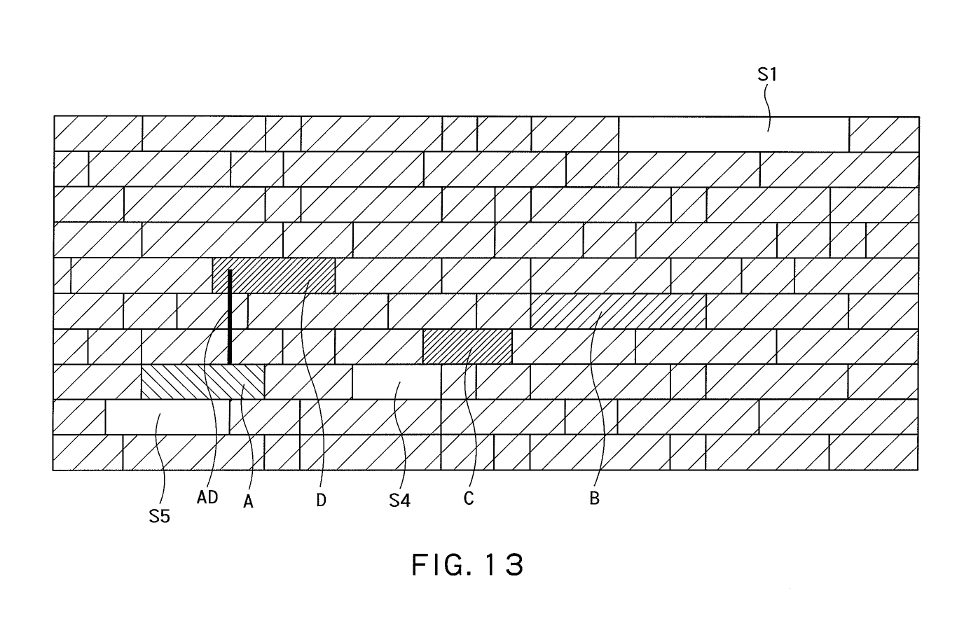

The layout modifier 123 adds the delay element selected in selecting delay element (S1105) and a new net to the circuit data. The new net connects the selected delay element and the logic cell connected to the net having the hold violation. After adding delay element (S1106), the flow returns to analyzing timing (S1101). That is, obtaining information for improving timing (S1103) to adding delay element (S1106) are repeated until the hold violation is eliminated. In output (S304) of FIG. 3, the circuit data having no hold violation is output as the layout of the semiconductor integrated circuit. FIG. 13 is a schematic diagram illustrating the layout of the semiconductor integrated circuit corresponding to the result of adding delay element (S1106) of FIG. 11. For example, as illustrated in FIG. 13, when a delay element C having the width of 3 [μm] and a delay element D having the width of 5 [μm] are selected in selecting delay element (S1105), the delay element D is added to the space S2 while the delay element C is added to the space S3, and a net AD connecting the logic cell A and the delay element D is added in adding delay element (S1106).

As described above, the layout modifier 123 searches the space information on the semiconductor integrated circuit based on the processing result of the logic modifier 122, selects the type and the size of the delay element to be added to the semiconductor integrated circuit based on the space information including the coordinate and the width of the space, and modifies the layout of the semiconductor integrated circuit using the selected delay element. As a result, the delay element is disposed near the logic cell connected to the net having the hold violation. Therefore, the length of the interconnection can be shortened.

In the embodiment, the first example of logic modification (S302) can be combined with the second example of logic modification (S302). Specifically, the designing apparatus 10 has a first mode that is used to perform the first example of logic modification (S302) and a second mode that is used to perform the second example of logic modification (S302). The logic modifier 122 performs the first mode when the command accepted from the user indicates that a higher priority is given to the processing speed, and performs the second mode when the command indicates that a higher priority is given to the processing result. The logic modifier 122 may perform the second mode after performing the first mode when the command indicates that a priority is given to both the processing speed and the processing result. Therefore, the designing method that meets the various demands of users can be realized.

According to the embodiment, various problems with the modification of the timing violation can be resolved. Particularly, the number of delay elements necessary to resolve the timing violation can be decreased. The problem that the delay elements necessary to modify the hold violation cannot be inserted can be resolved. Specifically, clock tree generation (S301) of FIG. 3 facilitates the modification of the hold violation. Logic modification (S302) of FIG. 3 can shorten the time necessary to modify the hold violation. Logic modification (S302) of FIG. 3 can improve both the accuracy of the modification and modification time of the hold violation. Layout modification (S303) of FIG. 3 can improve the shortening of the length of the interconnection.

At least a portion of a designing apparatus 10 according to the above-described embodiments may be composed of hardware or software. When at least a portion of the designing apparatus 10 is composed of software, a program for executing at least some functions of the designing apparatus 10 may be stored in a recording medium, such as a flexible disk or a CD-ROM, and a computer may read and execute the program. The recording medium is not limited to a removable recording medium, such as a magnetic disk or an optical disk, but it may be a fixed recording medium, such as a hard disk or a memory.

In addition, the program for executing at least some functions of the designing apparatus 10 according to the above-described embodiment may be distributed through a communication line (which includes wireless communication) such as the Internet. In addition, the program may be encoded, modulated, or compressed and then distributed by wired communication or wireless communication such as the Internet. Alternatively, the program may be stored in a recording medium, and the recording medium having the program stored therein may be distributed.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A designing apparatus comprising:
a clock tree generator configured to generate a clock tree;
a logic modifier configured to logically insert a delay element in such a manner that a hold violation is modified without considering a setup timing with respect to circuit data corresponding to the clock tree generated by the clock tree generator;
a layout modifier configured to modify a layout of a semiconductor integrated circuit based on a processing result of the logic modifier; and
an outputting module configured to output the layout of the semiconductor integrated circuit, the layout being modified by the layout modifier.

2. The apparatus of claim 1, wherein the logic modifier modifies a setup violation after the delay element is logically inserted.

3. The apparatus of claim 2, wherein the logic modifier eliminates the logically inserted delay element when the setup violation can not be modified.

4. The apparatus of claim 1, wherein the logic modifier analyzes a potential margin of the setup timing to the setup violation and logically inserts the delay element based on the potential margin.

5. The apparatus of claim 4, wherein the logic modifier logically inserts the delay element when the potential margin is included in a predetermined permissible range.

6. The apparatus of claim 1, wherein the logic modifier modifies the setup violation after the delay element is logically inserted in a first mode, and analyzes a potential margin of the setup timing to the setup violation and logically inserts the delay element based on the potential margin in a second mode.

7. The apparatus of claim 6, wherein the logic modifier eliminates the logically inserted delay element when the setup violation can not be modified in the first mode, and logically inserts the delay element when the potential margin is included in a predetermined permissible range in the second mode.

8. The apparatus of claim 6, wherein the logic modifier accepts a predetermined command, performs the first mode when the command indicates that a higher priority is given to a processing speed, and performs the second mode when the command indicates that a higher priority is given to a processing result.

9. The apparatus of claim 8, wherein the logic modifier performs the second mode after the first mode is performed when the command indicates that a priority is given to both the processing speed and the processing result.

10. The apparatus of claim 7, wherein the logic modifier accepts a predetermined command, performs the first mode when the command indicates that a higher priority is given to a processing speed, and performs the second mode when the command indicates that a higher priority is given to a processing result.

11. The apparatus of claim 10, wherein the logic modifier performs the second mode after the first mode is performed when the command indicates that a priority is given to both the processing speed and the processing result.

12. The apparatus of claim 1, wherein the clock tree generator changes the setup margin of the setup timing to the setup violation in the clock tree.

13. The apparatus of claim 1, wherein the layout modifier searches space information of the semiconductor integrated circuit based on the processing result of the logic modifier and modifies the layout of the semiconductor integrated circuit based on the space information.

14. The apparatus of claim 13, wherein the space information comprises a coordinate and a width of the space, and the layout modifier selects the delay element to be inserted.

15. The apparatus of claim 2, wherein the clock tree generator changes the setup margin of the setup timing to the setup violation in the clock tree.

16. The apparatus of claim 2, wherein the layout modifier searches space information of the semiconductor integrated circuit based on the processing result of the logic modifier and modifies the layout of the semiconductor integrated circuit based on the space information.

17. The apparatus of claim 16, wherein the space information comprises a coordinate and a width of the space, and the layout modifier selects the delay element to be inserted.

18. The apparatus of claim 3, wherein the clock tree generator changes the setup margin of the setup timing to the setup violation in the clock tree.

19. A designing method comprising:
generating a clock tree;
logically inserting a delay element in such a manner that a hold violation is modified without considering a setup timing with respect to circuit data corresponding to the clock tree;
modifying a layout of a semiconductor integrated circuit based on a result of logically inserting the delay element; and
outputting the modified layout of the semiconductor integrated circuit.

20. A computer readable medium comprising a computer program code for a designing method, the computer program code comprising:
generating a clock tree;
logically inserting a delay element in such a manner that a hold violation is modified without considering a setup timing with respect to circuit data corresponding to the clock tree;
modifying a layout of a semiconductor integrated circuit based on a result of logically inserting the delay element; and
outputting the modified layout of the semiconductor integrated circuit.
